(19) United States
(12) Patent Application Publication
(10) Pub. No.: US 2005/0280594 A1
(43) Pub. Date: Dec. 22, 2005

(54) Antenna rotor system

(76) Inventors: Robert Dennison, Waterbeach (GB); Alexander B. Chee, Marietta, GA (US)

Correspondence Address: Chun-Ming Shih, 4331 Stevens Battle Lane, Fairfax, VA, 22033, US

(21) Appl. No.: 10/857,840

(22) Filed: Jun. 2, 2004

(51) Int. Cl. H04N 5/62; H01Q 3/00

(52) U.S. Cl. 343/766

(57) ABSTRACT

An antenna rotor system with a single cable including an antenna, a rotor unit and a control unit is disclosed. The antenna is mounted on the rotor unit for receiving radio signals to pass to the rotor unit. The control unit provides control signals and electrical power to control and drive the rotor unit for rotating the antenna. The single cable connected between the rotor unit and the control unit carries the radio signals, the control signals and the electrical power. Therefore, the installation of the antenna rotor system of the present invention is simpler, faster and lower cost.

### FIELD OF THE INVENTION

The present invention relates in general to an antenna rotor system, and more particularly, to a TV antenna rotor system with a single coaxial cable transmitting both TV signals and rotor control signals, and also supplying electrical power to the outdoor rotor.

### BACKGROUND

Terrestrial TV broadcast stations are often located in different locations. This can lead to difficulties in local television reception. A typical outdoor TV antenna has certain directional characteristics. When an antenna points to one TV station for optimum reception, it usually leads to degraded reception for other TV stations in different directions and may have no reception for a few stations. This phenomenon is also significant for digital TV reception. The digital TV signal is easily and significantly degraded by multi-path signals, therefore, indoor and omnidirectional antennas are not typically effective. An outdoor directional antenna plus an antenna rotor is an effective solution for this type of application.

U.S. Pat. No. 4,301,397 to Journey, titled “DC ANTENNA ROTATOR SYSTEM”, has discussed a manual controlled TV antenna rotor system. The system is very basic and has no indicator or position control mechanism.

U.S. Pat. No. 4,446,407 to Sperber, titled “ANTENNA ROTATOR APPARATUS” has added feedback to the motor.

U.S. Pat. No. 4,542,326 to Hornback, titled “AUTOMATIC ANTENNA POSITIONING SYSTEM”, has incorporated a microprocessor to automatically control antenna to search for best signal positions.

U.S. Pat. No. 5,214,364 to Perdue et al., titled “MICROPROCESSOR-BASED ANTENNA ROTOR CONTROLLER”, has introduced a destination index method for rotation reference.

However, conventional TV antennas with rotors use a coaxial cable to transmit TV signals to the TV and a pair of electrical wires to control the rotor motor. The installers have to install two sets of cables or by a bundled cable. This can bring inconvenience to an installation.

### SUMMARY

The present invention is to simplify a TV antenna rotor system to use only one single coaxial cable so that the installation is simpler, faster and lower cost. Accordingly, this system includes two devices, an antenna rotor (drive unit) and a position controller. Both units have a microcontroller inside each unit to encode and decode the control communication protocol. The motor drive is part of the outdoor antenna rotor and power is supplied through the coaxial cable by the indoor position controller. The indoor position controller displays the rotor angle position, or other reference marker and encodes the control signals to the rotor. A handheld remote control may be used to interface with the position controller to change the antenna direction.

### BRIEF DESCRIPTION OF THE DRAWINGS

Following drawings with reference numbers and exemplary embodiments are referenced for explanation purpose.

FIG. 1 illustrates an antenna rotor system of the present invention;

FIG. 2 illustrates a block diagram of an indoor control unit according to the present invention.

FIG. 3 illustrates a block diagram of an outdoor rotor unit according to the present invention.

### DETAILED DESCRIPTION OF THE PREFERRED EMBODIMENTS

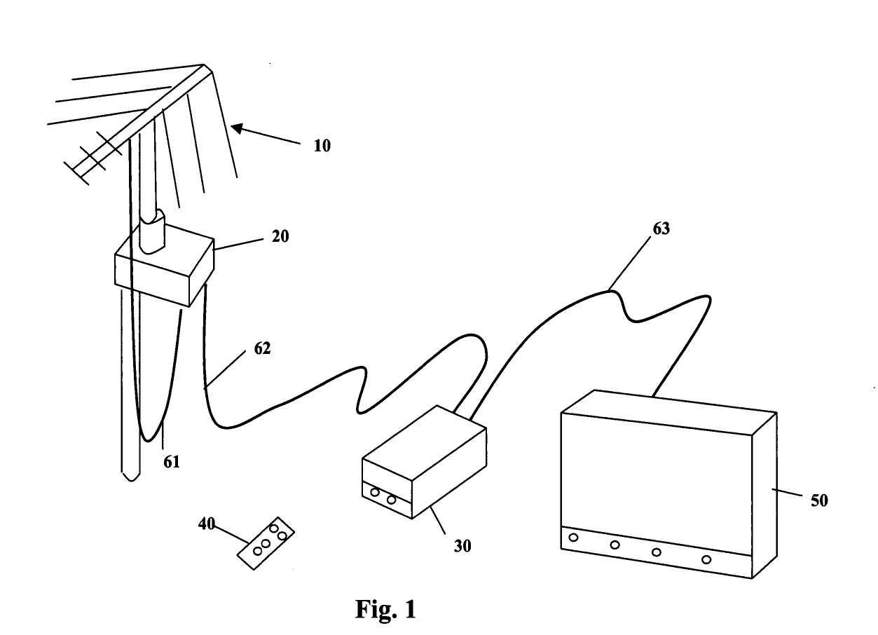

Referring to FIG. 1, an antenna rotor system using a single coaxial cable line is shown. The antenna rotor system includes an UHF/VHF (ultrahigh-frequency/very high frequency) antenna 10, an outdoor rotor unit 20 and an indoor control unit 30. The UHF/VHF antenna 10 is mounted on the rotor unit 20. The rotor unit 20 is connected to the control unit 30. The control unit 30 may be commanded by a remote control 40 for convenience and connects to a TV 50. UHF/VHF signals are received by the UHF/VHF antenna 10 and passed by a coaxial cable 61 to the rotor unit 20. The rotor unit 20 combines UHF/VHF signals into the coaxial cable 62 and passes them to the control unit 30. There are UHF/VHF signals, control signals (preferably, but not restricted to 22 KHz burst tones), and drive unit electrical power for the rotor unit 20 carried in the coaxial cable 62. Finally, UHF/VHF signals are sent to TV 50 through the coaxial cable 63.

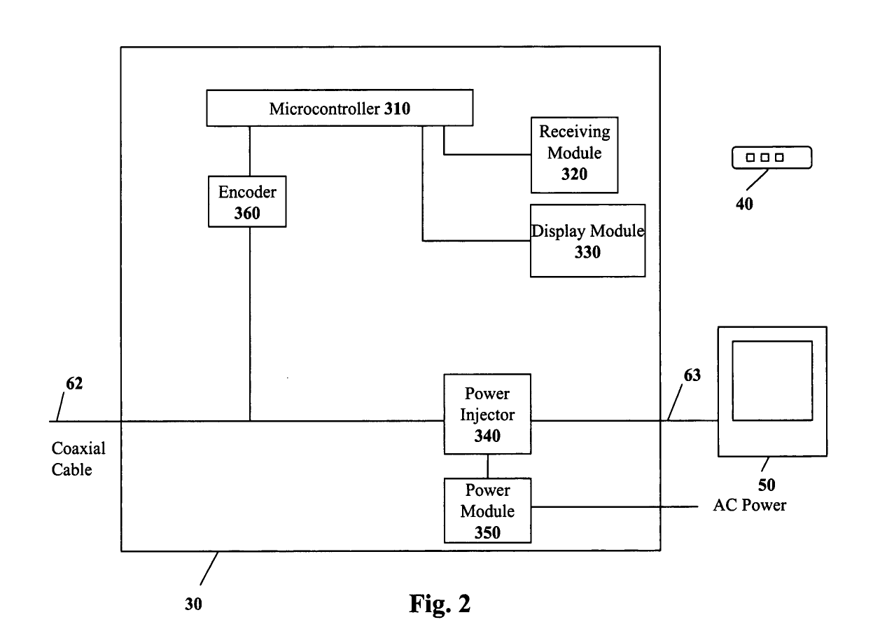

Referring to FIG. 2, the block diagram of the indoor control unit 30 is shown. The control unit 30 includes a microcontroller 310, a receiving module 320, a display module 330, a power injector 340, a power module 350 and an encoder 360. When the receiving module 320, preferably but not restricted to an infrared receiver, receives command signals from the remote control 40, the commands are translated into electrical signals and are sent to the microcontroller 310. The microcontroller 310 passes the signals to the control signal encoder 360. The control signals are then be passed to the rotor unit 20 through the coaxial cable 62. Therefore, the rotor unit 20 rotates according to the commands. Moreover, the control unit 30 indicates the rotor position on the display module 330. UHF/VHF signals are sent through coaxial cable 62 to the control unit 30 and are then sent to the TV 50 through coaxial cable 63. The electrical power module 350 connected to an AC power provides all power needs of all other modules in the control unit 30 and sends power to the power injector 340. The power injector 340 injects electrical power on to the coaxial cable 62 but blocks electrical power from passing to the coaxial cable 63 and TV 50. It also does not degrade the radio frequency (RF) performance between the ends of the coaxial cables 62 and 63.

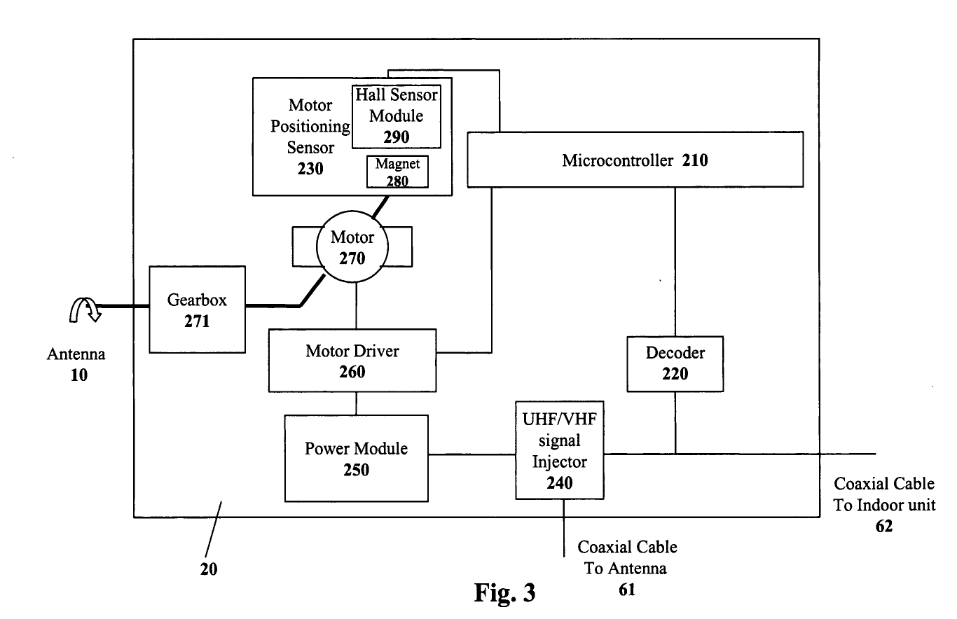

The outdoor rotor unit 20 is shown in FIG. 3. The rotor unit 20 includes microcontroller 210, a decoder 220, an UHF/VHF signal injector 240, a power module 250, a motor driver 260, a motor 270, a gear box 271, and a motor positioning sensor 230. The control signals sent from the control unit 30 are picked up by the control signal decoder 220 and then are sent to microcontroller 210. The microcontroller 210 controls the motor driver 260 according to the control signals from the control unit 30. The UHF/VHF signal injector 240 passes UHF/VHF signals from the antenna 10 to the coaxial cable 62 and back to a receiver of TV 50. The power module 250 supplies all the electrical power needs for the rotor unit 20. The electrical motor 270 is driven by the motor driver 260. Several types of motor positioning sensor are well known in use to work with the microcontroller 210 to control the motor 270. In this embodiment, preferably but not restricted to a Hall Effect position sensor is used as the motor positioning sensor 230. Other techniques including “pulse counting” per rotation, or a mechanical potentiometer to detect motor position can be used. For the Hall Effect position sensor, there is a magnet 280 attached to one end of the axis of the motor 270. There is a Hall sensor module 290 near to the magnet 280. The Hall sensor module 290 provides the counts of rotations of the motor 270. This information is sent to the microcontroller 210 and the information is used to calculate and adjust the angle position of the antenna 10. The gearbox 271 has the proper transmission ratio so that the rotor unit 20 can have sufficient torque to drive the antenna 10 and proper accuracy as needed. During turning, the microcontroller 210 compares the actual position with that commanded from the indoor control unit 30 and adjusts the position to match.

While the present invention has been particularly shown and described with reference to preferred embodiments thereof, it will be understood by those of ordinary skill in the art the various changes in form and details may be made therein without departing from the spirit and scope of the present invention as defined by the appended claims.

1. An antenna rotor system, comprising:
a rotor unit;
an antenna mounted on said rotor unit for receiving radio signals to pass to said rotor unit;
a control unit sending control signals and electrical power to control and drive said rotor unit for rotating said antenna; and
a single cable connected between said rotor unit and said control unit for carrying the radio signals, the control signals and the electrical power.

2. The antenna rotor system claimed as claim 1, wherein the radio signals are ultrahigh frequency/very high frequency signals.

3. The antenna rotor system claimed as claim 1, wherein said rotor unit further includes a microcontroller, a decoder and a motor, the control signals sent from said control unit are picked up by said decoder and then are sent to said microcontroller so that said motor is controlled by said microcontroller controls according to the control signals to rotate said antenna.

4. The antenna rotor system claimed as claim 3, wherein said rotor unit further includes a motor position sensor to detect a position of said motor.

5. The antenna rotor system claimed as claim 4, wherein said motor position sensor is a Hall Effect position sensor including a magnet attached to one end of the axis of said motor and a Hall sensor module for counting said motor to be calculated by said microcontroller so as to adjust the position of said antenna.

6. The antenna rotor system claimed as claim 4, wherein said motor position sensor is a pulse counting position sensor.

7. The antenna rotor system claimed as claim 4, wherein said motor position sensor is a mechanical potentiometer position sensor.

8. The antenna rotor system claimed as claim 3, wherein said rotor unit further includes a motor driver to drive said motor.

9. The antenna rotor system claimed as claim 3, wherein said rotor unit further includes a gearbox connected to said motor to drive said antenna.

10. The antenna rotor system claimed as claim 1, wherein said rotor unit further includes a signal injector to pass the radio signals from said antenna to said single cable.

11. The antenna rotor system claimed as claim 1, wherein said rotor unit further includes a power module to supply electrical power provided by said control unit for said rotor unit.

12. The antenna rotor system claimed as claim 1, furthering comprising a remote control for providing commands to said control unit, and said control unit further including a receiving module for receiving the commands to be translated into the control signals

13. The antenna rotor system claimed as claim 12, wherein said control unit further includes a microcontroller, a power module and an encoder, said microcontroller translates the commands to pass the control signals to said encoder and then to said rotor unit 20 through said single cable.

14. The antenna rotor system claimed as claim 12, wherein said receiving module is a infrared receiver.

15. The antenna rotor system claimed as claim 1, wherein said control unit further includes a power injector and an electrical power module connected to an AC power to send the electrical power to the power injector, said power injector injects the electrical power on to the single cable.

16. The antenna rotor system claimed as claim 1, wherein said single cable is a coaxial cable.
